(19) United States
(12) Patent Application Publication
(10) Pub. No.: US 2026/0024448 A1
(43) Pub. Date: Jan. 22, 2026

(54) GENERATION OF KEY TERMS FOR EDUCATIONAL STANDARDS USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventors: Akshay Mate, Nanaimo (CA); Janet Demir, Ortaca (TR); Matthew Caponi, Vancouver, WA (US); Nima Shirazian, Austin, TX (US); Niraj Patel, Dubai (AE); Sean Carlson, Austin, TX (US)

(73) Assignee: 2hr Learning, Inc., Austin, TX (US)

(21) Appl. No.: 19/273,066

(22) Filed: Jul. 17, 2025

Related U.S. Application Data
(60) Provisional application No. 63/672,408, filed on Jul. 17, 2024.

(51) Int. Cl. G09B 5/02

(52) U.S. Cl. CPC G09B 5/02

(57) ABSTRACT

The system and method for guiding an Artificial Intelligence (AI) engine to generate a set of key terms relevant to educational standards. The system and method involve receiving input data including educational standards and key term types from educational curriculum guidelines, configuring a quality bar comprising metrics such as standard relevance, category fit, curriculum alignment, and correctness, and generating a prompt to guide the AI engine for generating key terms. An algorithm is then applied involving iterative prompt refinement and selection of key terms based on the quality bar metrics. This includes generating initial key terms using the AI engine, evaluating the generated key terms against the quality bar metrics, and refining the prompts iteratively based on the evaluation to improve the relevance and accuracy of the key terms. Furthermore, the prompt is transferred to the AI engine to generate a final set of key terms aligned with the educational standards.

### CROSS-REFERENCE TO RELATED APPLICATION(S)

This application claims the benefit under 35 U.S.C. § 119(c) and 37 C.F.R. § 1.78 of U.S. Provisional Application No. 63/672,408, which is incorporated by reference in its entirety.

### FIELD OF THE INVENTION

The present invention relates in general to the field of electronics, and more specifically to a key terms generation system to generate a set of key terms relevant to educational standards.

### BACKGROUND

Educational content facilitates the students to a diverse range of materials and resources across various subjects and disciplines. The conventional approach to generating educational content has been a manual and time consuming process. The conventional method primarily relies on the expertise and diligence of subject matter experts (SMEs) to meticulously craft key terms and align with educational standards. The traditional method requires human oversight and input, which require a high degree of accuracy and relevance. The traditional approach is labor-intensive in nature. The SMEs are highly qualified individuals with extensive knowledge in their respective fields who are tasked with the exhaustive process of identifying key concepts and terms that are essential for a given subject area. This involves a deep dive into existing educational standards and curriculums, followed by a careful selection of terms that align with the educational guidelines. The complexity of the task is compounded by the need to ensure that the selected terms not only meet the educational standards but are also pedagogically sound and appropriate for the targeted student demographic.

Furthermore, the manual nature of the conventional approach is prone to inconsistencies. Since the generation of educational content is largely dependent on the individual expertise and judgment of the SMEs, there can be significant variability in the quality and relevance of the content produced. Different SMEs might interpret educational standards differently or prioritize different aspects of the curriculum, leading to variations in the key terms selected and the content created. This lack of standardization can result in educational materials that are uneven in quality, potentially affecting the learning outcomes of students. In addition to inconsistencies, delays in content delivery are another significant problem associated with the traditional approach. The extensive time required to manually generate and align educational content with educational standards means that there is often a lag between the identification of new educational needs and the availability of corresponding materials. In fast-evolving fields, the delay can hinder the timely provision of relevant and up-to-date content to students, educators, and educational institutions.

Additionally, the SMEs utilize textbooks, academic journals, educational databases, and other resources. Reading through multiple textbooks and curriculum guidelines was an exhaustive task, often requiring the SME to cross-reference information and ensure consistency across different sources. However, the quality and comprehensiveness of the resources can vary, impacting the effectiveness of the content generation process. Moreover, the evolving landscape of educational standards and curricular frameworks adds another layer of complexity to the traditional approach. Educational standards are periodically revised to reflect new research findings, societal changes, and evolving educational priorities. Keeping pace with these changes and ensuring that educational content remains aligned with updated standards requires ongoing vigilance and adaptation by SMEs.

Furthermore, The SME had to evaluate the importance of various historical events and figures, determining which ones were essential for inclusion and which could be omitted or given less emphasis. This evaluative process was subjective to some extent, influenced by the SMEs perspective and understanding of historical significance. As a result, different SMEs might produce slightly different lists of key terms, each reflecting their unique interpretation of the course material.

### SUMMARY

In at least one embodiment, a method integrates programmatic control and a guided and constrained Artificial Intelligence (AI) engine to generate a set of key terms relevant to educational standards. The method includes executing code using one or more processors of a computer system to cause the computer system to perform operations. The operations include receiving input data, where the input data includes educational standards and key term types from educational curriculum guidelines. The operations include configuring a quality bar, which includes metrics such as standard relevance, category fit, curriculum alignment, and correctness. The operations include generating a prompt to guide the AI engine for generating key terms. The operations include applying an algorithm involving iterative prompt refinement and selection of key terms based on the quality bar metrics. The algorithm includes generating initial key terms using the AI engine based on the educational standards and key term types, evaluating the generated key terms against the quality bar metrics, and refining the prompts iteratively based on the evaluation to improve the relevance and accuracy of the key terms. The operations include transferring the prompt to the AI engine to generate a final set of key terms aligned with the educational standards.

In at least one embodiment, a system integrates programmatic control and a guided and constrained Artificial Intelligence (AI) engine to generate a set of key terms relevant to educational standards. The system includes one or more processors of a computer system and a memory, coupled to the one or more processors, storing code that, when executed, causes the computer system to perform operations. The operations include receiving input data, where the input data includes educational standards and key term types from educational curriculum guidelines. The operations include configuring a quality bar, which includes metrics such as standard relevance, category fit, curriculum alignment, and correctness. The operations include generating a prompt to guide the AI engine for generating key terms. The operations include applying an algorithm involving iterative prompt refinement and selection of key terms based on the quality bar metrics. The algorithm includes generating initial key terms using the AI engine based on the educational standards and key term types, evaluating the generated key terms against the quality bar metrics, and refining the prompts iteratively based on the evaluation to improve the relevance and accuracy of the key terms. The operations include transferring the prompt to the AI engine to generate a final set of key terms aligned with the educational standards.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary key terms generation system to generate a set of key terms relevant to educational standards.

FIG. 2 depicts an exemplary key terms generation process utilized by the key terms generation system.

FIG. 3 depicts an education generation process, which is an embodiment of the key terms generation process of FIG. 2.

FIG. 4 depicts a key term refinement process, which is an embodiment of the key terms generation process of FIG. 2.

FIG. 5 depicts an educational key terms generation process, which is an embodiment of the key terms generation process of FIG. 2.

FIG. 6 depicts a final key terms set generation process, which is an embodiment of the key terms generation process of FIG. 2.

FIG. 7 is a sequence diagram for generating key terms.

FIG. 8 depicts a response generation process, which is an embodiment of the key terms generation process of FIG. 2.

FIG. 9 depicts a data structure for generating key terms.

FIG. 10 depicts an exemplary network environment in which the system of FIG. 1 and the process of FIG. 2 may be practiced.

FIG. 11 depicts an exemplary computer system.

### DETAILED DESCRIPTION

The system and method for guiding an Artificial Intelligence (AI) engine to generate a set of key terms relevant to educational standards. The system and method involve receiving input data including educational standards and key term types from educational curriculum guidelines, configuring a quality bar comprising metrics such as standard relevance, category fit, curriculum alignment, and correctness, and generating a prompt to guide the AI engine for generating key terms. An algorithm is then applied involving iterative prompt refinement and selection of key terms based on the quality bar metrics. This includes generating initial key terms using the AI engine, evaluating the generated key terms against the quality bar metrics, and refining the prompts iteratively based on the evaluation to improve the relevance and accuracy of the key terms. Furthermore, the prompt is transferred to the AI engine to generate a final set of key terms aligned with the educational standards.

The AI engine is capable of automatically generating key terms across various key term types, including people, events, places, objects, processes and systems, concepts and theories, and documents policies laws tied to the educational standards. The algorithm utilized by the AI engine to generate initial key terms, evaluation against quality bar metrics, and prompt refinement to improve the relevance and accuracy of the key terms. Furthermore, the utilization of a data model enables the generation and evaluation of key terms. Additionally, the Subject Matter Expert (SME) reviews the generated key terms for quality assurance, providing feedback to refine and validate the accuracy, relevance, and alignment of the key terms with the educational standard. Moreover, a curriculum fitness check is utilized by running prompts on each Key Term-standard pairing to assess curriculum alignment, to ensure the generated key terms are not only relevant but also aligned with educational standards and assigning ratings to each Key Term-standard pairing based on its relevance to the educational standard, allowing for the filtering of key terms based on their ratings, thus ensuring that only highly relevant and essential key terms are selected for mastering the standard.

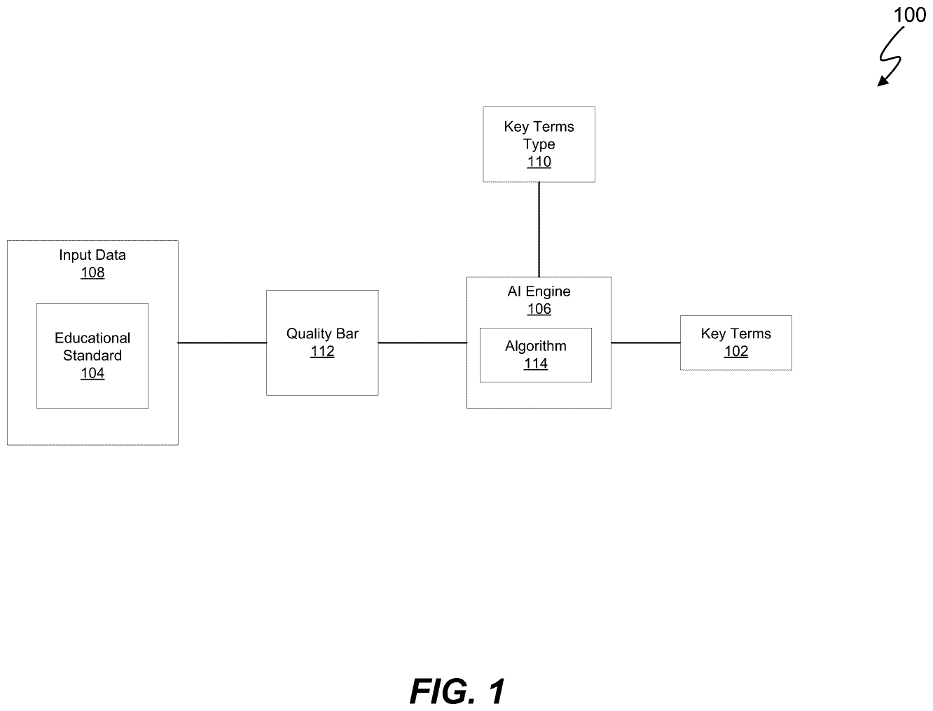

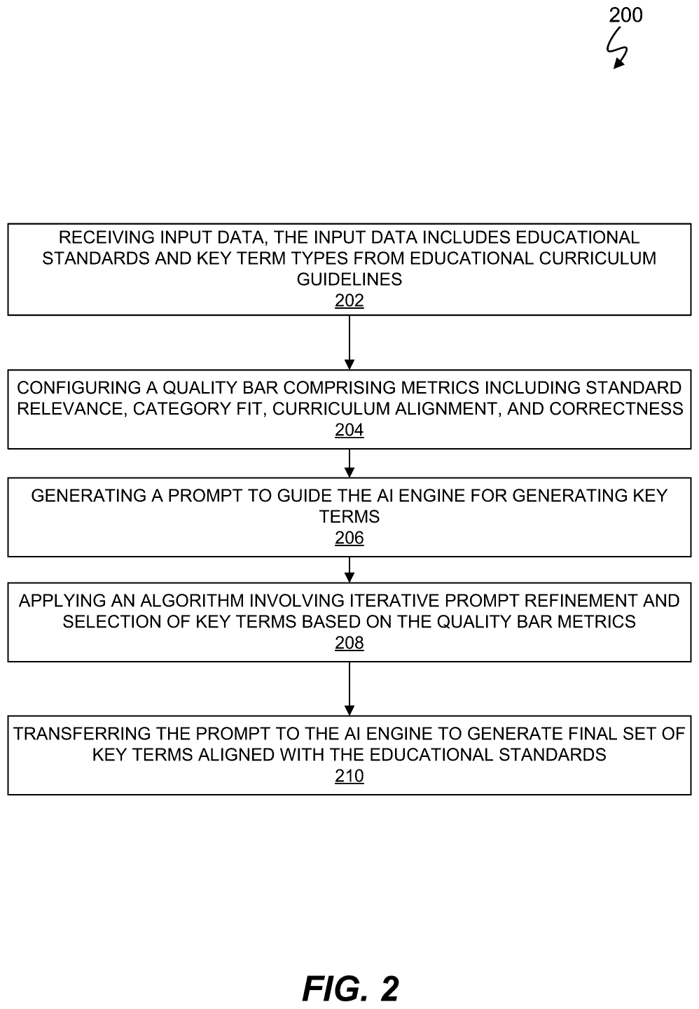

FIG. 1 depicts an exemplary key terms generation system 100 to generate a set of key terms 102 relevant to educational standards 104. FIG. 2 depicts an exemplary key terms generation process 200 utilized by the key terms generation system 100.

The key terms generation system 100 includes an Artificial Intelligence (AI) engine 106 to generate a set of key terms 102. Typically, the key terms 102 play a vital role in generating high-quality, focused, and relevant educational content, such as Multiple Choice Questions (MCQs) and Free Response Questions (FRQs) for educational standards 104. The AI engine 106 is configured to identify the key terms 102 relevant to the educational standards 104 and generate key terms 102 while ensuring accuracy and alignment with educational standards 104.

Referring to FIGS. 1 and 2, in operation 202, the key terms generation system 100 is configured to receive input data 108. The input data 108 includes educational standards 104 and key term types 110 from educational curriculum guidelines. The educational curriculum guidelines are established by educational authorities to outline the expected learning outcomes and competencies the user should achieve at different stages of their educational standards 104. The educational curriculum guidelines encompass subjects and grade levels, ensuring that the educational material aligns with the overall educational goals and standards set by the educational authorities. The educational standards 104 serve as benchmarks to identify what the user should know and be able to do at each grade level and in each subject area. The educational standards 104 ensure that the educational content is comprehensive, relevant, and achievable. The user can be a student, learner, tutor, researcher, and so forth.

The key term types 110 refer to specific concepts, vocabulary, and terminologies required for understanding the subject matter outlined in the educational curriculum guidelines. The key term types 110 includes people, events, places, objects, processes and systems, concepts and theories, and documents policies laws are utilized in enhancing the creation of educational content. The key terms types 110 help to organize and structure information in a way that aligns with educational objectives and educational curriculum guidelines. For example, identifying and incorporating key terms 102 related to people, such as historical figures, helps to contextualize and make learning relatable for the user. The events, including significant historical milestones or scientific discoveries, provide a chronological framework that aids in understanding the progression of knowledge and societal development. The places, like geographic locations or important sites, enhance geographical and cultural awareness. The objects, encompassing physical items or artifacts, bring tangibility to abstract concepts. The processes and systems, such as biological processes or technological systems, clarify complex mechanisms and interactions. The concepts and theories, including scientific principles or philosophical ideas, form the foundation of deeper understanding and critical thinking. The documents policies laws, covering legal texts or regulatory frameworks, impart knowledge of governance and societal structures. By categorizing key terms 102, the educational content can be automatically generated in a structured, comprehensive, and pedagogical manner, ensuring that the user receives a well-rounded and cohesive educational experience. For example, in a science curriculum, key terms 102 include concepts such as “photosynthesis,” “gravity,” and “molecular structure.” In a mathematics curriculum, key terms 102 include “algebra,” “geometry,” and “probability.” By identifying and incorporating the key terms 102 into the input data 108, the educational content delivered is relevant, accurate, and in line with the curriculum guidelines.

The receiving of the input data 108 requires identification and extraction of relevant educational standards 104 and key term types 110 from the curriculum guidelines. The extracted data is then organized and formatted in a way that can be easily integrated. Once the input data 108 has been received and formatted, the input data 108 can be utilized to enhance the educational experience. For example, the input data 108 can be used to create personalized learning paths for the user, ensuring that the user is exposed to the right content at the right time based on their individual progress and needs. Moreover, the input data 108 can be used to create adaptive learning environments that dynamically adjust the difficulty and complexity of the content based on the performance and understanding of the user. Furthermore, the curriculum guidelines are often updated periodically to reflect new research findings, technological advancements, and changes in educational priorities. By continuously receiving and integrating updated input data, allows the user with the up to date and accurate information.

In operation 204, configuring a quality bar 112 comprising metrics including standard relevance, category fit, curriculum alignment, and correctness. The quality bar 112 involves establishing a comprehensive set of criteria that ensures the educational material meets standards of quality, accuracy, and educational value to enhance the learning experience for the users. The quality bar 112 comprises metrics including standard relevance, category fit, curriculum alignment, and correctness. The standard relevance refers to the degree to which the educational content aligns with the established educational standards 104 and learning objectives. The educational standards 104 are set by educational authorities and are designed to ensure that the user acquire the necessary knowledge and skills at each stage of their education. The standard relevance maintains consistency and coherence across different educational resources, ensuring that the users receive a standardized level of education. The category fit assesses how well the educational content fits into the predefined categories or key term types 110, such as people, events, places, objects, processes and systems, concepts and theories, and documents policies laws. The category fit ensures that the content is organized logically. For example, the content categorized under “concepts and theories” should provide a clear and thorough explanation of theoretical frameworks, while content under “processes and systems” should detail the steps and interactions within various systems. Ensuring category fit enhances the clarity and usability of the educational content.

The curriculum alignment evaluates how well the educational content aligns with the specific curriculum guidelines. The curriculum guidelines are tailored to reflect the educational priorities and values of a specific locale, taking into account cultural, social, and historical contexts. By aligning educational content with the curriculum guidelines, to ensure the education material is relevant and applicable to the learning environment of the user. The curriculum alignment also helps to bridge the gap between theoretical knowledge and practical application. The correctness assesses the accuracy and reliability of the educational content. The correctness ensures that the information presented is factually correct, well-researched, and based on credible sources. The correctness maintains the integrity and credibility of the educational material, as inaccuracies can lead to misunderstandings and misinformation. The correctness also encompasses the precision of language and terminology used in the educational content, ensuring that key terms 102 are used appropriately and consistently. In addition to evaluation, the quality bar 112 provides development and enhancement of educational content. By providing clear guidelines and benchmarks, to help in creating high-quality material that meets the required standards

In operation 206, generating a prompt to guide the AI engine 106 for generating key terms 102. Typically, the prompt serves as the initial instruction that informs the AI engine 106 about the generating key terms 102. The prompt provides a setting clear expectations and parameters for the AI engine 106 for generating the output. The AI engine, such as ChatGPT by OpenAI. The prompt is generated after understanding the subject matter and the educational goals associated. The prompt must analyze the curriculum guidelines, identify the core concepts and competencies that the user is expected to learn, and understand the context in which the key terms 102 will be used. For example, in a history curriculum, the key terms 102 include significant historical figures, events, and places, while in a science curriculum, the key terms 102 might encompass scientific principles, processes, and terminology.

The prompt specifies the key terms type 110 required, such as names of people, events, places, objects, processes, systems, concepts, theories, documents, policies, or laws. Additionally, the prompt provides examples to illustrate the desired output and set boundaries to ensure the generated key terms 102 are within the scope of the subject matter. In at least one embodiment, a prompt for generating key terms 102 in a biology lesson include instructions like, “Generate a list of key terms related to cellular biology, including cell structures, functions, and processes. Examples include ‘mitochondria,’ ‘photosynthesis,’ and ‘cell membrane.’” The prompt provides any necessary constraints, such as the grade level of the user, to ensure that the complexity of the key terms 12 matches the understanding of the user.

Below is an exemplary input for the prompt to generate “People” type key terms:

| | |
|---|---|
| Course | AP World History |
| Domain | The Global Tapestry |
| Cluster | Comparison in the Period from c. 1200 to c. 1450 |
| Educational | As the Abbasid Caliphate fragmented, new Islamic political |
| Standard | entities emerged, most of which were dominated by Turkic |
| | peoples. These states demonstrated continuity, innovation, |
| | and diversity. |

Below is an exemplary prompt utilizing the exemplary input for generating “People” type key terms:

```
  Background
  You are a subject matter expert specialized in { { course } }. You want to create a
comprehensive list of ALL key people strongly related to an educational standard that
students need to know and remember. You will list the people and describe their
importance to the educational standard.
  Task:
  1. Review the given “Course”, “Domain”, “Cluster”, and “Educational Standard”
and base your outputs on this information.
  2. Generate a comprehensive list of ALL the essential people that are
indispensable to understanding the given “Educational Standard” and could be seen in
textbook examples.
  3. Ensure each person is relevant to the “Educational Standard” and has a detailed
explanation of why they are related to the “Educational Standard”.
  4. Respond with the list of people and explanations as outlined in the “Output
Format”.
  Rules
  1. All people and the explanations of why they were listed must be completely
accurate, thoroughly documented, and agreed upon in the field related to the given
“Course”.
  2. All explanations must contain the critical details needed to understand how
each person relates to the “Educational Standard”.
  3. All explanations must be between 20-30 words long.
  4. Your response must exactly follow the “Output Format”.
  Output Format
  Format your response in valid JSON format with the following fields:
  {
  “people”: [
    {
    “name”: “”,
    “explanation”: “”
    },
    ...
  ]
  }
  Core Data
  Course: AP World History
  Domain: The Global Tapestry
  Cluster: Comparison in the Period from c. 1200 to c. 1450
  Educational Standard: As the Abbasid Caliphate fragmented, new Islamic
political entities emerged, most of which were dominated by Turkic peoples. These states
demonstrated continuity, innovation, and diversity.
```

Prompt explanation:

This prompt outlines a task to create a comprehensive list of key people (historical figures) relevant to a particular educational standard 104. The information about the course, domain, cluster, and educational standards 104 must be reviewed to generate an accurate and documented list of essential people. Each person listed must have a detailed explanation of their relevance to the educational standards 104, with explanations containing critical details and being between 20-30 words long. All information is accurate and agreed upon in the field related to AP World History focusing on the Global Tapestry from c. 1200 to c. 1450.

Below is an output for the exemplary prompt for generating “People” type key terms:

```
{
  “people”: [
  {
    “name”: “Osman I”,
    “explanation”: “He founded the Ottoman Empire, a prominent Turkic state,
showcasing continuity, innovation, and diversity in the Islamic world.”
  },
  {
    “name”: “Genghis Khan”,
    “explanation”: “His Mongol Empire influenced Turkic states, fostering continuity
and diversity in the Islamic political landscape.”
  },
  {
    “name”: “Timur”,
    “explanation”: “Timur established a prominent Turkic-Mongol empire,
consolidating power in the Islamic world amidst the fragmentation of the Abbasid
Caliphate.”
  },
  {
    “name”: “Seljuq Dynasty founders”,
    “explanation”: “The Seljuks took over Baghdad, marking a shift in Islamic power
towards Turkic peoples.”
  }
  ]
}
```

In operation 208, applying an algorithm 114 involves iterative prompt refinement and selection of key terms 102 based on the quality bar 112 metrics. The algorithm 114 generates key terms 102 and also ensures the relevance, accuracy, and alignment of the key terms 102 with educational standards 104 and curriculum guidelines through continuous refinement and evaluation. The creation of the prompt instructs the AI engine 106 to generate key terms 102. The prompt is crafted based on an in-depth understanding of the subject matter, educational goals, and the specific requirements of the curriculum. For example, a prompt for a history curriculum instructs the AI engine 106 to generate key terms 102 related to significant events, figures, and periods, while a science curriculum prompt focuses on scientific principles, processes, and terminologies.

The algorithm 114 begins by generating initial key terms 102 using the AI engine 106 based on educational standards 104 and key term types 110, for developing quality educational content. The AI engine 106 extracts relevant and meaningful key terms 102 from a vast array of educational materials. The initial generation of key terms 102 is guided by a set of educational standards 104 and key term types 110, ensuring that the output aligns with the learning objectives and curriculum guidelines. The educational standards 104 serve as benchmarks for what the user should know and be able to do at various stages of education. The algorithm ensures that the generated key terms 102 are pertinent to the required learning outcomes.

The prompt provides instructions to the AI engine 106, specifying the type of key terms 110 required and offering examples to illustrate the desired output. The AI engine 106 identifies and extracts key terms 102 that are central to the subject matter and aligned with the educational standards 104. The initial set of key terms 102 generated by the AI engine 106 is then subjected to a preliminary evaluation to ensure the key terms 102 meets quality criteria. The generated key terms 102 are evaluated against the quality bar 112 metrics. The evaluation includes checking for relevance to the educational standards 104, proper categorization according to the key term types 110, and general accuracy and appropriateness for the intended grade level.

Refining the prompts iteratively based on evaluation to enhance the relevance and accuracy of key terms generated 102 by the AI engine 106. The evaluation involves assessing the key terms 102 against predefined quality bas 112 metrics such as standard relevance, category fit, curriculum alignment, and correctness. The feedback from the evaluation is used to refine the prompt. The refinement process involves adjusting the instructions given to the AI engine 102 to provide clearer, specific guidance. For example, if the initial key terms 102 were too broad or vague, the prompt is updated to narrow the focus. The refined prompt is then used to generate a new set of key terms 102, which are again evaluated against the quality bar 112 metrics. The cycle of evaluation and refinement continues iteratively, with each round of adjustments informed by the feedback from the previous iteration. Moreover, the prompts generated ensures that the AI engine 106 generates the key terms 102 that are relevant and accurate, avoiding generic or irrelevant outputs.

In operation 210, transferring the prompt to the AI engine 106 to generate the final set of key terms 102 aligned with the educational standards 104. The refined instructions derived from evaluation and adjustment are provided to the AI engine 106 to produce key terms 102. The refined prompt ensures that the AI engine 106 understands the scope and context of the key terms 102 to be generated. For example, if the prompt specifies generating key terms 102 related to significant scientific discoveries of the 20th century, the AI engine 106 focus on terms like “DNA structure,” “quantum mechanics,” and “penicillin discovery,”

Typically, the generation of the final set of key terms 102 is a dynamic process. Moreover, during the generation of the final set of key terms 102, the AI engine 106 considers the categorization within key term types 110. By adhering to the specified categories to ensure that the key terms 102 are organized logically and can be easily integrated into the educational content. For instance, in a history curriculum, terms categorized under “Events” include “American Civil War” and “French Revolution,” while “People” feature “George Washington” and “Marie Curie.” The final set of key terms 102 are used for integration into the educational content. Moreover, the final set of key terms 102 helps to standardize the educational content, ensuring consistency and coherence across different topics and grade levels.

Below is the pseudo code for generating the set of key terms 102 relevant to educational standards 104:

```
  # Function to generate key terms using GPT-4
  function generateKeyTerms(standard, keyTermTypes):
    # Initialize an empty list to store generated key terms
    generatedKeyTerms = [ ]
    # Loop through each key term type
    for type in keyTermTypes:
      # Construct the GPT-4 prompt based on the standard and key term type
      prompt = constructPrompt(standard, type)
      # Call GPT-4 API with the constructed prompt
      response = callGPT4API(prompt)
      # Parse the response and add the key terms to the list
      generatedKeyTerms.extend(parseResponse(response))
    # Return the list of generated key terms
    return generatedKeyTerms
  # Function to construct GPT-4 prompt
  function constructPrompt(standard, type):
    # Define the prompt template
    promptTemplate = “Generate key terms for the standard {standard} of type
{type}.”
    # Replace placeholders with actual values
    prompt = promptTemplate.replace(“{standard}”, standard).replace(“{type}”,
type)
    # Return the constructed prompt
    return prompt
  # Function to call GPT-4 API
  function callGPT4API(prompt):
    # API call to GPT-4 with the prompt
    # This is a placeholder for the actual API call
    response = GPT4API.call(prompt)
    # Return the API response
    return response
  # Function to parse GPT-4 response
  function parseResponse(response):
    # Parse the response to extract key terms
    # This is a placeholder for the actual parsing logic
    keyTerms = response.parse( )
    # Return the parsed key terms
    return keyTerms
  # Main execution flow
  keyTermTypes = [“People”, “Events”, “Places”, “Objects”, “Processes &
Systems”, “Concepts & Theories”, “Documents Policies Laws”]
  standard = “Example Educational Standard”
  generatedKeyTerms = generateKeyTerms(standard, keyTermTypes)
```

Utilizing a Subject Matter Expert (SME) to review the generated key terms 102 for quality assurance and ensuring the standards of accuracy, relevance, and alignment with educational standards 104. The role of the SME begins once the AI engine 106 generates the set of key terms 102 based on the refined prompts. The key terms 102 generated aligned with educational standards 104, require an SME examination to ensure the generated key terms 102 meet quality bar 112 metrics established for the content. The SME assesses the generated key terms 102 to reflect the educational standards 104, ensuring that they are pertinent to what the user is expected to learn. For example, in a biology course, a key term 102 like “photosynthesis” and cellular respiration.” must be defined and contextualized within the broader learning goals related to plant biology.

Moreover, the SME ensures that each key term 102 is correctly classified to maintain a structured and coherent educational framework. The SME also checks whether the generated key terms 102 align with curricular requirements by verifying the key terms 102 are appropriate for the grade level and subject matter, ensuring the key terms 102 are neither too advanced nor too simplistic. For example, terms like “quantum mechanics” might be suitable for high school physics but would be inappropriate for middle school science. In at least one embodiment, the SME provides detailed feedback for refining the key terms 102 and making necessary adjustments. The SME suggest modifications to the wording of the key terms 102, corrections to factual inaccuracies, reclassification of miscategorized key terms 102, or addition of new key terms 102

Moreover, utilizing a data model, the data model includes structures for educational standards 104, key term types 110, and quality bar 112 metrics to support the generation and evaluation of key terms 102. The educational standards 104 provide the foundational criteria for evaluating the relevance of the key terms 102. For example, the educational standards 104 for a high school biology course include understanding cellular structures, genetic principles, and ecological systems. The AI engine 106 generates an initial set of key terms 102, the key terms 102 are evaluated against the quality bar 112 metrics embedded in the data model.

Moreover, performing a curriculum fitness check by utilizing the AI engine 106 by running prompts on each Key Term-standard pairing to assess curriculum alignment. The AI engine 106 is configured to perform curriculum fitness checks twice on each Key Term-standard pairing. The curriculum fitness check process begins with the generation of initial key terms 102 paired with relevant educational standards 104. Each pairing represents a specific learning objective that the key term 102 is expected to address. For example, the key term 102 like “photosynthesis” paired with a standard that requires the user to understand the process by which plants convert light energy into chemical energy. Once the pairing is established, the AI engine 106 runs prompts on each key term-standard pairing. The prompts are designed to evaluate how well the key term 102 aligns with the educational standards 104 paired with. The AI engine 106 analyzes the context, relevance, and accuracy of the key term 102 in relation to the educational standards 104.

During the first round of curriculum fitness checks, the AI engine 106 identifies key terms 102 that do not fully align with the paired educational standards 104. Based on the feedback from the first round of checks, the key terms 102 are refined to better align with the respective educational standards 104. The second round of checks validates the refinements made after the first round of assessment. The double-checking process minimizes the risk of errors and ensures that the key terms 102 are thoroughly vetted for curriculum alignment. Performing curriculum fitness checks twice on each key term-standard pairing provides a robust mechanism for quality assurance.

Furthermore, assigning ratings from 1-10 to each Key Term-standard pairing based on relevance to the educational standards 104 for both runs. The ratings indicate how essential the key term 102 is for understanding and mastering the corresponding educational standards 104. Typically, during the evaluation, the AI engine 106 assigns a rating from 1 to 10 to each Key Term-standard pairing. A rating of 1 indicates that the key term 102 has minimal relevance to the educational standards 104, while a rating of 10 signifies that the key term 102 is highly essential for understanding and mastering the standard. The ratings provide a quantitative measure of how well each key term 102 supports the learning objectives defined by the educational standards 104.

During the first run of curriculum fitness, the AI engine 106 evaluates each key term-standard pairing and assigns rating. The key terms 102 undergo a refinement process by revising the definitions, providing additional context, or enhancing the specificity of the terms 102 to align with the educational standards 104. The second round of ratings serves to validate the improvements made during the refinement process. By comparing the initial and subsequent ratings, the second run of curriculum fitness rating assigns second rating.

Furthermore, filtering key terms 102 based on the ratings. Typically, the ratings range from 1 to 10, with higher ratings indicating greater relevance and alignment. During the first run of curriculum fitness checks, the AI engine 106 evaluates each key term-standard pairing and assigns initial ratings. The ratings provide a preliminary assessment of each key term 102 relevance. Following the initial assessment, the key terms 102 are refined and aligned with the educational standards 104. The filtering process uses the ratings to determine which key terms 102 are retained. If both the initial and subsequent ratings for a key term-standard pairing are 6 or above, the key term 102 is considered highly relevant indicating that the key term 102 supports the educational standards 104. On the other hand, if either run results in a rating below 6, the key term 102 is discarded. A rating below 6 indicates that the key term 102 does not sufficiently support the educational standards 104, either due to lack of clarity, insufficient coverage of the necessary concepts, or misalignment with the learning objectives. The filtering mechanism ensures that the final set of key terms 102 is both accurate and aligned with the educational standards 104. The filtering mechanism removes ambiguity and redundancy, ensuring that the final set of key terms 102 is comprehensive, focused, and aligned with learning objectives.

Below is an exemplary input for generating prompt for running curriculum fitness on “People” type key terms:

| | |
|---|---|
| Key Terms | Osman I |
| Educational | As the Abbasid Caliphate fragmented, new Islamic political |
| Standard | entities emerged, most of which were dominated by Turkic |
| | peoples. These states demonstrated continuity, innovation, |
| | and diversity. |
| Course | AP World History |

is an exemplary prompt for running curriculum fitness on “People” type key terms

Course: AP World History
Standard: As the Abbasid Caliphate fragmented, new Islamic political entities emerged,
most of which were dominated by Turkic peoples. These states demonstrated continuity,
innovation, and diversity.
Key Term: Osman I
Key Term Specifications
Key Term Definition: The Key Term to be rated is a person related to the Standard. The
person, by definition, can be any real historical or present-day person and can refer to a
single individual or a group of people.
Rating Guidelines
A rating of 10 should be given if:
- The Key Term is extremely likely to appear on a final exam of the Course.
- The Key Term is extremely likely to appear on an in-class quiz or unit test of the
Course.
- A Course student CANNOT master the Standard without knowing and understanding
the Key Term.
A rating of 9 should be given if:
- The Key Term is very likely to appear on a final exam of the Course.
- The Key Term is extremely likely to appear on an in-class quiz or unit test of the
Course.
- A Course student is very unlikely to master the Standard without knowing and
understanding the Key Term.
A rating of 7 should be given if:
- The Key Term is likely to appear on a final exam of the Course.
- The Key Term is very likely to appear on an in-class quiz or unit test of the Course.
- A Course student is unlikely to master the Standard without knowing and
understanding the Key Term.
A rating of 5 should be given if:
- The Key Term is unlikely to appear on a final exam of the Course.
- The Key Term is likely to appear on an in-class quiz or unit test of the Course.
- A Course student may be able to master the Standard without knowing and
understanding the Key Term.
A rating of 3 should be given if:
- The Key Term is very unlikely to appear on a final exam of the Course.
- The Key Term is unlikely to appear on an in-class quiz or unit test of the Course.
- A student of the Course is very likely to master the Standard without knowing and
understanding the Key Term.
A rating of 1 should be given if:
- The Key Term is extremely unlikely to appear on a final exam of the Course.
- The Key Term is very unlikely to appear on an in-class quiz or unit test of the Course.
- The Key Term is irrelevant to the Standard, and a Course student does not need to
know or understand it to master the Standard.
Examples
Example 1:
* Course: AP Biology
* Standard: Natural selection is a major mechanism of evolution. Assess via an example.
* Key Term: Charles Darwin
Rating: 10
Example 2:
* Course: AP United States History
* Standard: United States policymakers engaged in a cold war with the authoritarian
Soviet Union, seeking to limit the growth of Communist military power and ideological
influence, create a free-market global economy, and build an international security
system.
* Key Term: Nikita Khrushchev
Rating: 9
Example 3:
* Course: AP World History: Modern
* Standard: The causes of World War II included the unsustainable peace settlement after
World War I, the global economic crisis engendered by the Great Depression, continued
imperialist aspirations, and especially the rise to power of fascist and totalitarian regimes
that resulted in the aggressive militarism of Nazi Germany under Adolf Hitler.
* Key Term: Emperor Hirohito
Rating: 7
Example 4:
* Course: AP World History: Modern
* Standard: Nationalism also became a major force shaping the historical development of
states and empires.
* Key Term: Sun Yat-sen
Rating: 5
Example 5:
* Course: AP Biology
* Standard: Use data from the parental phenotype/genotype to predict the offspring of a
monohybrid cross.
* Key Term: Hugo de Vries
Rating: 3
Example 6:
* Course: AP United States History
* Standard: Franklin Roosevelt's New Deal attempted to end the Great Depression by
using government power to provide relief to the poor, stimulate recovery, and reform the
American economy
* Key Term: Huey Long
Rating: 1

Prompt explanation:

This prompt evaluates the significance of a key historical figure, Osman I, in relation to an educational standard 104 for an AP World History course. The educational standard 104 focuses on the emergence of new Islamic political entities dominated by Turkic peoples following the fragmentation of the Abbasid Caliphate, highlighting continuity, innovation, and diversity. The key term 102, Osman I, must be rated based on its relevance and likelihood of appearing on exams and quizzes. Ratings range from 10 (critical for mastering the standard) to 1 (irrelevant to the standard). The rating criteria specify how indispensable the term is for users to understand and succeed in mastering the educational standard 102, with detailed examples provided for context.

Below is the output for the about curriculum fitness run

Output for Run 1
8
Output for Run 2
2

Since both runs result in a rating above 6, thus, the key term 102 is retained.

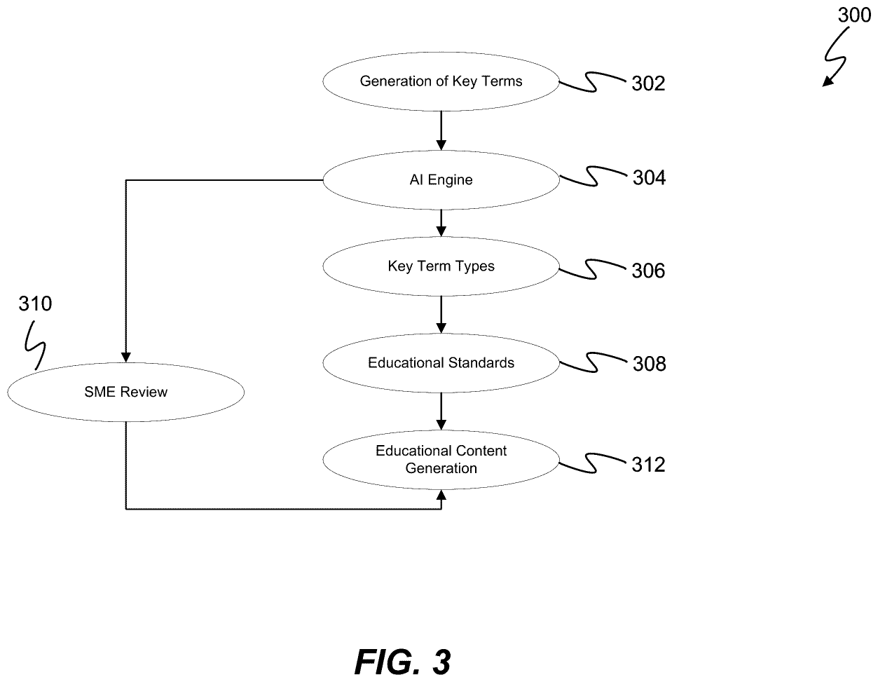

FIG. 3 depicts an education generation process 300, which is an embodiment of key terms generation process 200 of FIG. 2. As shown, at step 302 the generation of the key term 102 begins. At step 304, the AI engine 106 is configured to generate the key terms 102. At step 306, the key terms generated are categorized into key terms types 110. At step 308, the generated key terms are aligned with the educational standards 104. At step 310, the AI engine 106 generated key terms are provided to the SME for review. At step 312, the based on the SME review and aligned key terms 102 with the educational standard is used to generate education content.

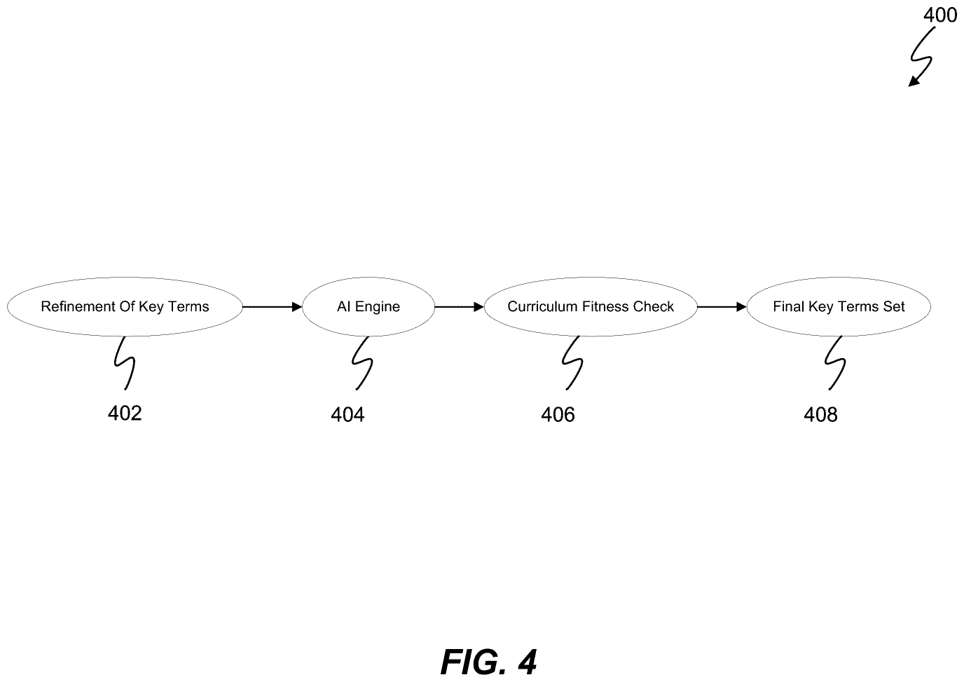

FIG. 4 depicts a key term refinement process 400, which is an embodiment of key terms generation process 200 of FIG. 2. As shown, at step 402 the refinement of the key term 102 begins. The refinement of key terms in educational content enhance the relevance, accuracy, and alignment with educational standards 104. The refinement of key terms ensures that key terms 102 effectively support learning objectives and provide clear, precise, and useful information for the user. At step 404, the AI engine 106 is configured to refine the key terms 102. At step 406, the AI engine 106 is configured to perform curriculum fitness checks to assign ratings from 1-10 to each key term 102. At step 408, the AI engine 106 generates final key terms.

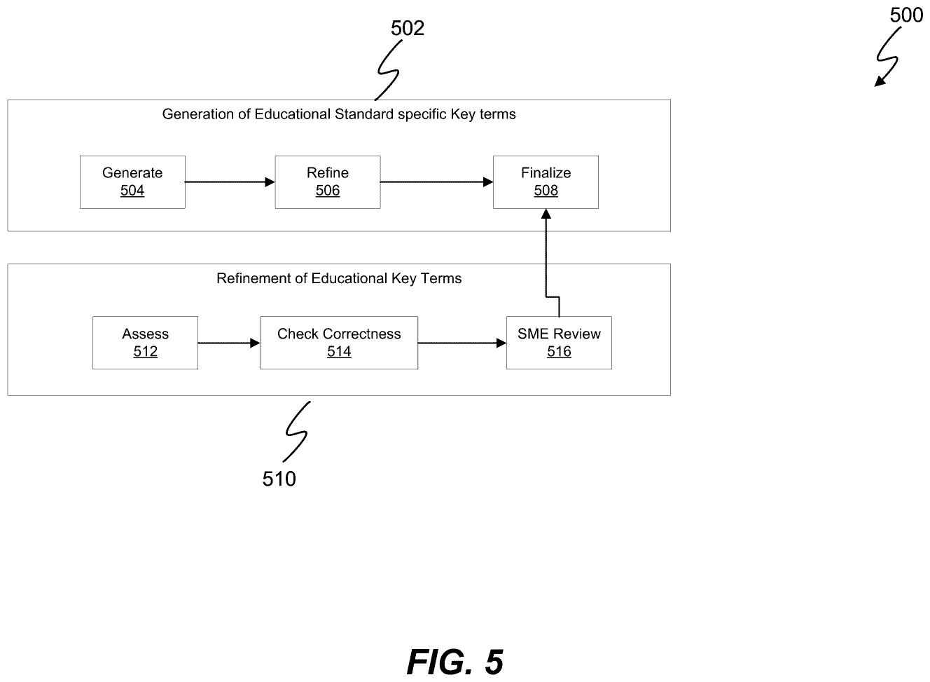

FIG. 5 depicts an educational key terms generation process 500, which is an embodiment of key terms generation process 200 of FIG. 2. As shown, generation of educational standard specific key terms 502 includes generate 504, refine 506 and finalize 508 of the key terms 102. The generate 504 enable in generating the key terms 102, refine 506 enable in refining the generated key terms 102 and finalize 508 enable in finalizing the refined key terms 102. Moreover, refinement of educational key terms 510 includes assess 512, check correctness 514 and SME review 516. The assess 512 evaluates the key terms 102 to determine effectiveness and relevance in the educational context. The check correctness 514 verifies the accuracy and appropriateness of the key terms 102 to ensure alignment with educational standards 104. The SME review 516 involves seeking input and feedback to validate and improve the quality of the key terms 102 and provided to the finalize 508.

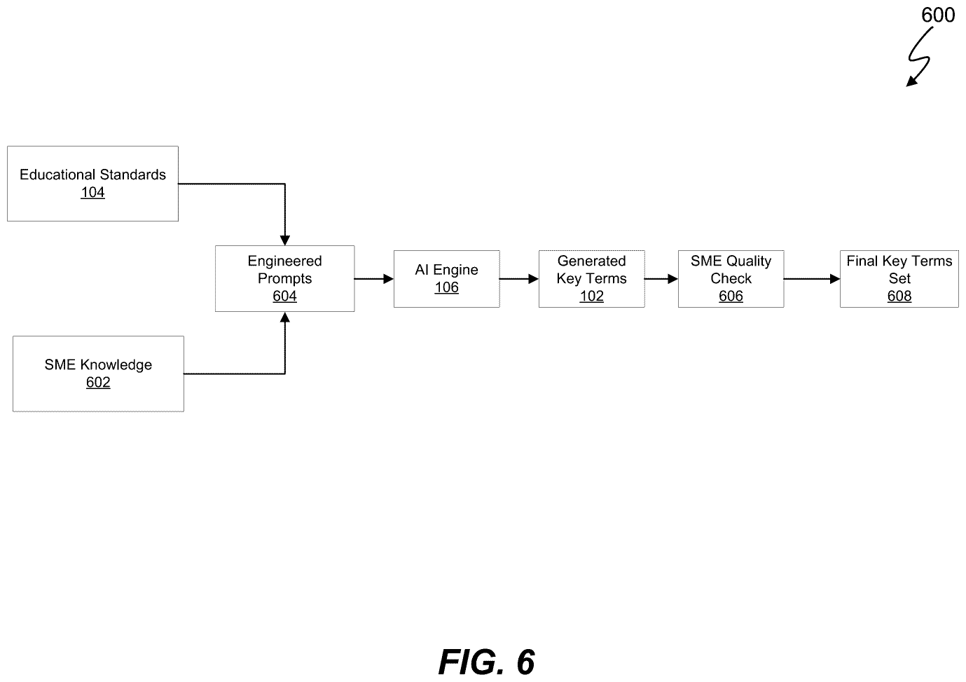

FIG. 6 depicts a final key terms set generation process 600, which is an embodiment of key terms generation process 200 of FIG. 2. As shown the educational standards 104 and SME knowledge 602 is used to generate prompts 604. The generated prompts 604 are provided to the AI engine 106. The AI engine 106 based on the prompts 604 provided are utilized to generate the key terms 102. The key terms 102 generated are provided for SME quality check 606. Based on the SME quality check 606 final key terms set 608 is generated

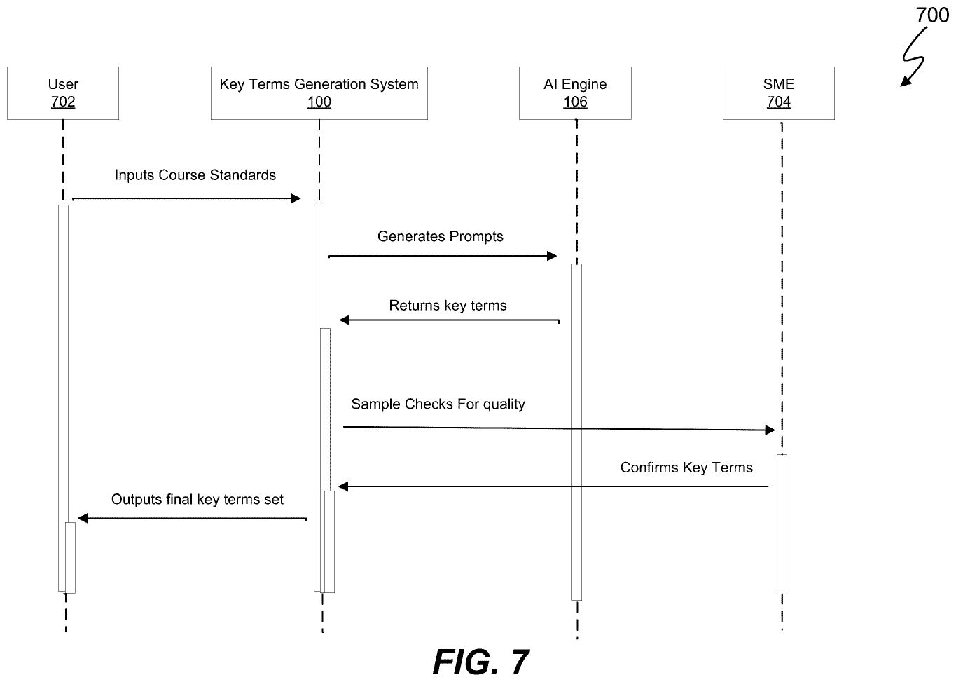

FIG. 7 is a sequence diagram 700 for generating key terms 102. As shown, a user 702 provides input course standard. The input course standard provided by the user 702 is received by the key terms generation system 100. The key terms generation system 100 is configured to generate the prompts. The generated prompts are provided to the AI engine 106. The AI engine 106 is configured to generate the key terms 102 based on the provided prompts. The key terms 102 are received by the key terms generation system 100 and are provided to SME 704. The SME 704 analyzes the generated key terms 102 and confirms the generated key terms 102 and provides to the key terms generation system 100. The key terms generation system 100 provided the output final key terms 102 to the user 702.

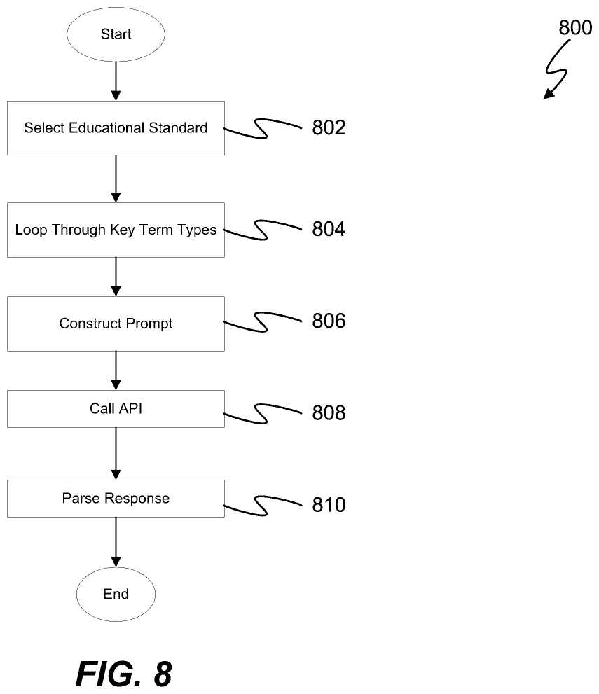

FIG. 8 depicts a response generation process 800, which is an embodiment of key terms generation process 200 of FIG. 2. As shown, at step 802 educational standards 104 is selected. At step 804, loop through key term types to identify relevant key term types 110. At step 806, construct a prompt for key term generation. At step 808, call AI engine API to provide the constructed prompt. At step 810, parse response generated by the AI engine 106.

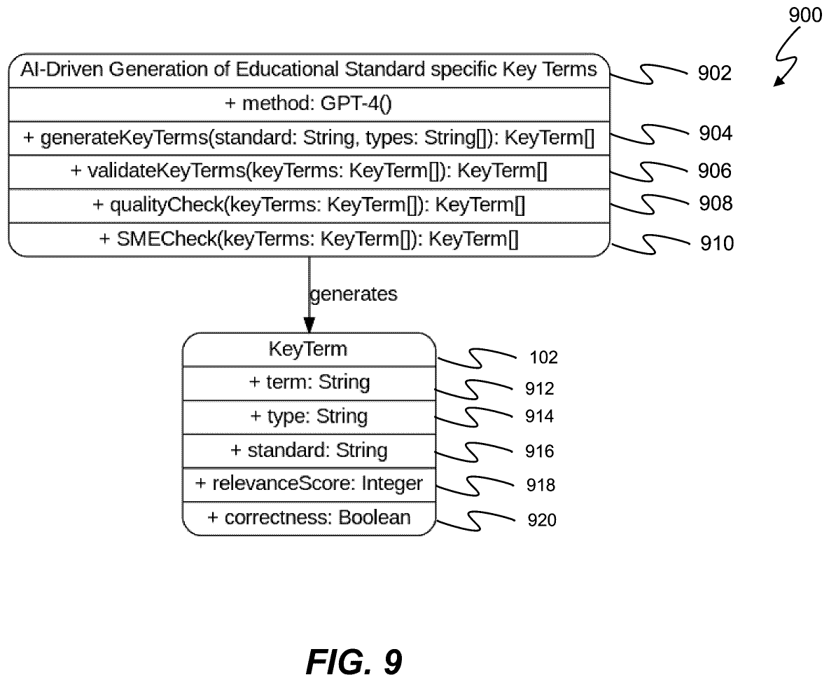

FIG. 9 depicts a data structure 900 for generating key terms 102. The data structure 900 includes AI driven generation of educational standard specific key terms 902. The AI driven generation of educational standard specific key terms 902 includes generate key terms 904, validate key terms 906, quality check 908 and SME check 910. The generated key terms 904 is configured to generate the key terms 102 by utilizing AI engine 106. The validate key terms 906 validates the generated key terms 102. The quality check 908 checks the quality of the generated key terms 102. The SME check 910 also checks for any ambiguity in the generated key terms 102. The AI driven generation of educational standard specific key terms 902 is configured to generate the key terms 102. The key terms 102 includes term 912, type 914, standard 916, relevance score 918 and correctness 920. The term 912 is the specific key term 102 generated by the AI driven generation of educational standard specific key terms 902. The type 914 is the key term type 110. The standard 916 is the specific education standards 104 for which the key term 102 is generated. The relevance score 918 depicts the relevance of the generated key term 102 with the specific education standards 104. The correctness 920 is the level of correctness of the generated key terms 102.

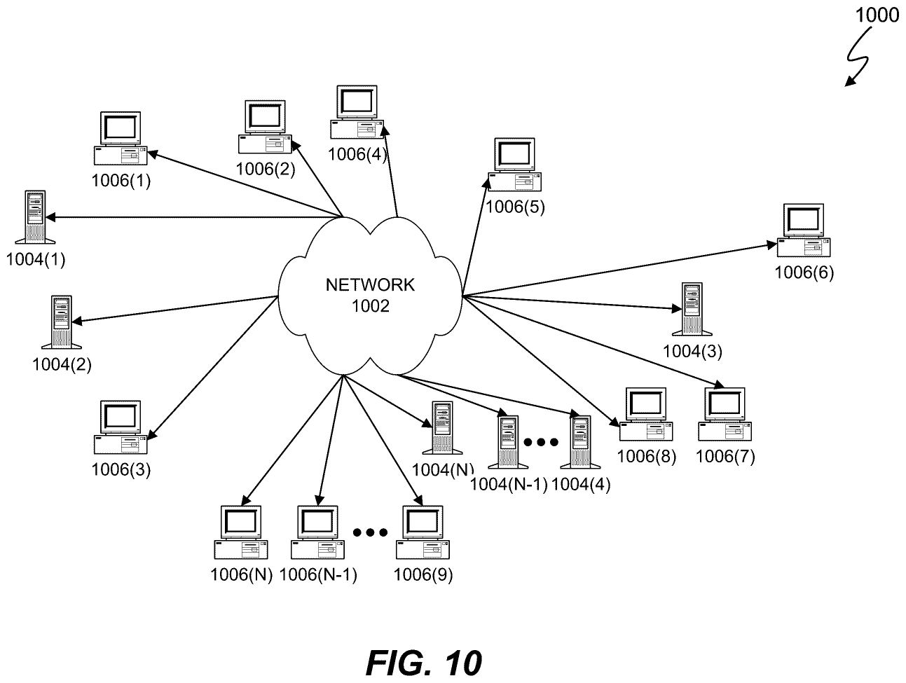

FIG. 10 is a block diagram illustrating a network environment in which a key terms generation system 100 and key terms generation process 200 may be practiced. Network 1002 (e.g. a private wide area network (WAN) or the Internet) includes a number of networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example communications channels providing T1 or OC3 service. Client computer systems 1006(1)-(N) typically access server computer systems 1004(1)-(N) through a service provider, such as an internet service provider (“ISP”) by executing application specific software, commonly referred to as a browser, on one of client computer systems 1006(1)-(N).

Client computer systems 1006(1)-(N) and/or server computer systems 1004(1)-(N) are specialized computer programmed to improve conventional computer systems to implement and utilize the key terms generation system 100 and key terms generation process 200. The type of computer system that can be specially programmed to implement and utilize the key terms generation system 100 and key terms generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the key terms generation system 100 and key terms generation process 200 can be implemented using code stored in a tangible, non-transient computer readable medium and executed by one or more processors. In at least one embodiment, the key terms generation system 100 and key terms generation process 200 can be implemented completely in hardware using, for example, logic circuits and other circuits including field programmable gate arrays.

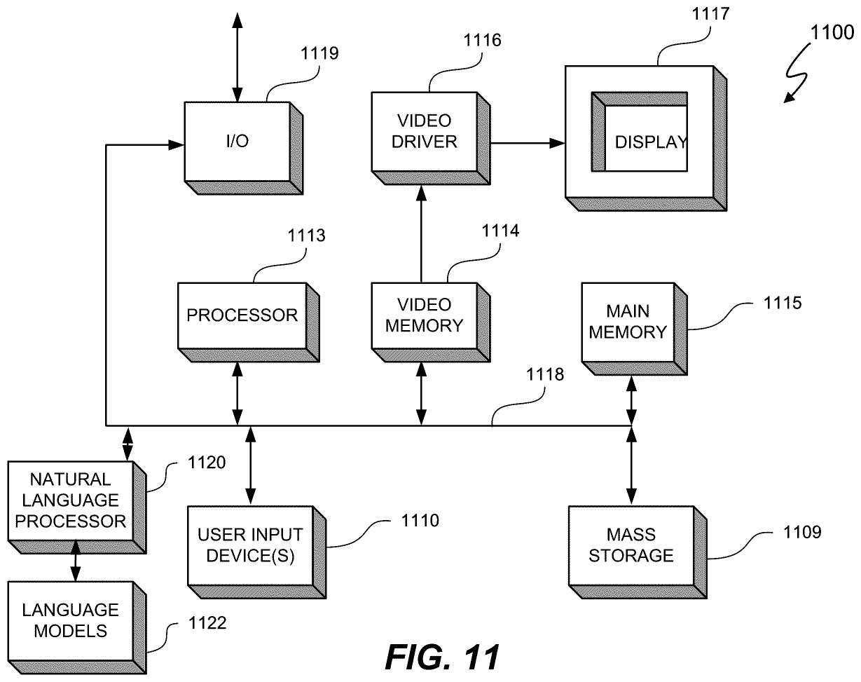

Embodiments of the key terms generation system 100 and key terms generation process 200 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1109, all coupled to bi-directional system bus 1118 along with input user device(s) 1110 and processor 1113. The mass storage 1109 may include both fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 1118 also includes, for example, an n-bit data bus for transferring DATA between and among the components, such as CPU 1109, main memory 1115, video memory 1114 and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer systems via a telephone link or to the Internet via an ISP. I/O device(s) 1119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1109, into main memory 1115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the display 1117. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The key terms generation system 100 and key terms generation process 200 may be implemented in any type of computer system or programming or processing environment. It is contemplated that the key terms generation system 100 and key terms generation process 200 might be run on a stand-alone computer system, such as the one described above. The key terms generation system 100 and key terms generation process 200 might also be run from a server computer systems system that can be accessed by a plurality of client computer systems interconnected over an intranet network. Finally, the key terms generation system 100 and key terms generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method that integrates programmatic control and a guided and constrained Artificial Intelligence (AI) engine to to generate a set of key terms relevant to educational standards comprising:
executing code using one or more processors of a computer system to cause the computer system to perform operations comprising:
receiving input data wherein the input data includes educational standards and key term types from educational curriculum guidelines;
configuring a quality bar comprising metrics including standard relevance, category fit, curriculum alignment, and correctness;
generating a prompt to guide the AI engine for generating key terms;
applying an algorithm involving iterative prompt refinement and selection of key terms based on the quality bar metrics, wherein the algorithm comprises:
generating initial key terms using the AI engine based on the educational standards and key term types;
evaluating the generated key terms against the quality bar metrics; and
refining the prompts iteratively based on the evaluation to improve the relevance and accuracy of the key terms; and
transferring the prompt to the AI engine to generate a final set of key terms aligned with the educational standards.

2. The method of claim 1 wherein the AI engine automatically generates key terms across multiple types, including people, events, places, objects, processes and systems, concepts and theories, and documents policies laws tied to the educational standards.

3. The method of claim 1 wherein generating the prompts to ensure that the AI engine generates key terms that are relevant and accurate, avoiding generic or irrelevant outputs.

4. The method of claim 1 further comprising:
utilizing a data model, wherein the data model includes structures for educational standards, key term types, and quality metrics to support the generation and evaluation of key terms.

5. The method of claim 1 further comprising
utilizing a Subject Matter Expert (SME) to review the generated key terms for quality assurance, wherein the SME evaluates the terms against the defined quality bar metrics to provide feedback to refine and validate the accuracy, relevance, and alignment of the key terms with the educational standard.

6. The method of claim 1 further comprising:
performing a curriculum fitness checks by utilizing the AI engine by running prompts on each Key Term-standard pairing to assess curriculum alignment, wherein the AI engine is configured to perform curriculum fitness checks twice on each Key Term-standard pairing.

7. The method of claim 1 further comprising
assigning ratings from 1-10 to each Key Term-standard pairing based on relevance to the educational standards for both runs, wherein the ratings indicate how essential the key term is for understanding and mastering the corresponding educational standard.

8. The method of claim 7 wherein the key terms are filtered based on the ratings:
if both runs result in a rating of 6 or above out of 10 for a Key Term-standard pairing, the key term is selected as highly relevant and essential for mastering the standard; or
if either run results in a rating below 6 out of 10 for a Key Term-standard pairing, the key term is discarded as it is deemed not sufficiently essential for mastering the standard.

9. A system that integrates programmatic control and a guided and constrained Artificial Intelligence (AI) engine to to generate a set of key terms relevant to educational standards comprising:
one or more processors;
one or more processors of a computer system; and
a memory, coupled to the one or more processors, storing code that when executed causes the computer system to perform operations comprising:
receiving input data wherein the input data includes educational standards and key term types from educational curriculum guidelines;
configuring a quality bar comprising metrics including standard relevance, category fit, curriculum alignment, and correctness;
generating a prompt to guide the AI engine for generating key terms;
applying an algorithm involving iterative prompt refinement and selection of key terms based on the quality bar metrics, wherein the algorithm comprises:
generating initial key terms using the AI engine based on the educational standards and key term types;
evaluating the generated key terms against the quality bar metrics; and
refining the prompts iteratively based on the evaluation to improve the relevance and accuracy of the key terms;
transferring the prompt to the AI engine to generate a final set of key terms aligned with the educational standards.

10. The system of claim 9 wherein the AI engine automatically generates key terms across multiple types, including people, events, places, objects, processes and systems, concepts and theories, and documents policies laws tied to the educational standards.

11. The system of claim 9 wherein generating the prompts to ensure that the AI engine generates key terms that are relevant and accurate, avoiding generic or irrelevant outputs.

12. The system of claim 9 wherein data in the input data model includes structures for educational standards, key term types, and quality metrics to support the generation and evaluation of key terms.

13. The system of claim 9 wherein the memory stores code that when executed causes the computer system to further perform operations comprising:
utilizing a Subject Matter Expert (SME) to review the generated key terms for quality assurance, wherein the SME evaluates the terms against the defined quality bar metrics to provide feedback to refine and validate the accuracy, relevance, and alignment of the key terms with the educational standard.

14. The system of claim 9 wherein the memory stores code that when executed causes the computer system to further perform operations comprising:
performing curriculum fitness checks by utilizing the AI engine by running prompts on each Key Term-standard pairing to assess curriculum alignment, wherein the AI engine is configured to perform curriculum fitness checks twice on each Key Term-standard pairing.

15. The system of claim 14 wherein the memory stores code that when executed causes the computer system to further perform operations comprising:
assigning ratings from 1-10 to each Key Term-standard pairing based on relevance to the educational standard for both runs, wherein the ratings indicate how essential the key term is for understanding and mastering the corresponding educational standard.

16. The system of claim 9 wherein the key terms are filtered based on the ratings:
if both runs result in a rating of 6 or above out of 10 for a Key Term-standard pairing, the key term is selected as highly relevant and essential for mastering the standard; and
if either run results in a rating below 6 out of 10 for a Key Term-standard pairing, the key term is discarded as it is deemed not sufficiently essential for mastering the standard.
